(19) United States
(12) Patent Application Publication
(10) Pub. No.: US 2007/0171340 A1
(43) Pub. Date: Jul. 26, 2007

(54) Display apparatus and method of fabricating the same

(75) Inventor: Young-Wook Lee, Suwon-si (KR)

Correspondence Address: F. CHAU & ASSOCIATES, LLC, 130 WOODBURY ROAD, WOODBURY, NY, 11797, US

(73) Assignee: Samsung Electronics Co.

(21) Appl. No.: 11/651,847

(22) Filed: Jan. 10, 2007

(30) Foreign Application Priority Data
Jan. 24, 2006 (KR) 10-2006-07424

(51) Int. Cl. G02F 1/1335

(52) U.S. Cl. 349/114

(57) ABSTRACT

A display apparatus includes a substrate including a display area having a transmissive region and a reflective region and a peripheral area surrounding the display area, a gate line and a data line formed on the substrate and crossing each other to define a pixel area in the display area, a gate electrode and a common electrode, wherein the gate electrode branches from the gate line in the pixel area and the common electrode is spaced apart from the gate electrode, a source electrode and a drain electrode formed on the gate electrode, wherein the source electrode branches from the data line and the drain electrode is spaced apart from the source electrode, and a reflective electrode formed in the pixel area by extending the drain electrode into the pixel area and provided with at least one opening to define the transmissive region and the reflective region.

### CROSS-REFERENCE TO RELATED APPLICATION

This application claims priority to Korean Patent Application No. 2006-07424 filed on Jan. 24, 2006, the contents of which are herein incorporated by reference in their entirety.

### BACKGROUND OF THE INVENTION

1. Technical Field

The present disclosure relates to a display apparatus and a method of fabricating the same, and more particularly, to a transflective type display apparatus having a wider viewing angle and a method of fabricating the same.

2. Discussion of the Related Art

Slim-type display apparatuses provided with flat display panels are used to display images. For example, a liquid crystal display (LCD) device is used for, for example, notebook computers or mobile communication terminals. The LCD device employs liquid crystal maintained in the mesomorphic phase representing the characteristics of both liquid phase and solid phase. The liquid crystal has an anisotropic refractive index, so the transmittance of light passing through the liquid crystal may vary depending on the alignment of liquid crystal molecules. Due to the anisotropic refractive index of the liquid crystal, the LCD device employing the liquid crystal may have a narrow viewing angle and the image displayed in the LCD device can be seen as a distorted image when the image is viewed from a lateral side of the LCD device.

Since the liquid crystal is not self-emissive, light is provided to the liquid crystal to display images. The light can be provided to the liquid crystal externally, or a light emitting device can be installed in the LCD device to provide internal light to the liquid crystal. The LCD devices can be reflective type LCD devices, transmissive type LCD devices, and transflective type LCD devices according to light sources including, for example, an internal light source, an external light source, or a combination thereof.

An example of the external light can be a natural light such as, for example, daylight. An example of the internal light can be an artificial light such as, for example, light emitted from a light emitting diode (LED) lamp. The reflective type LCD devices receive natural light from an exterior of the device, and the transmissive type LCD devices receive artificial light from an internal light emitting device installed in the LCD device. Since the transmissive type LCD devices use the internal light, the transmissive type LCD devices can display images even in places without sufficient external light, but cause more power consumption than the reflective type LCD devices. The reflective type LCD devices can use less power as compared to the transmissive type LCD devices.

However, the reflective type LCD devices cannot be used in places without sufficient external light. The transflective type LCD devices can be selectively operated in the reflective mode or in the transmissive mode according to the intensity and ambient brightness of the external light.

The transflective type LCD device includes a reflective electrode, which reflects light incident thereon from the exterior. The reflective electrode can be obtained by patterning a conductive layer. However, the number of processing steps and the manufacturing cost increase due to the additional patterning process.

### SUMMARY OF THE INVENTION

Embodiments of the present invention provide a transflective type display apparatus capable of widening a viewing angle thereof while reducing the number of processing steps and the manufacturing cost, and a method of fabricating the transflective type display apparatus.

According to an embodiment of the present invention, a display apparatus includes a substrate including a display area having a transmissive region and a reflective region and a peripheral area surrounding the display area, a gate line and a data line formed on the substrate and crossing each other to define a pixel area in the display area, a gate electrode and a common electrode, wherein the gate electrode branches from the gate line in the pixel area and the common electrode is spaced apart from the gate electrode, a source electrode and a drain electrode formed on the gate electrode, wherein the source electrode branches from the data line and the drain electrode is spaced apart from the source electrode, and a reflective electrode formed in the pixel area by extending the drain electrode into the pixel area and provided with at least one opening to define the transmissive region and the reflective region.

According to an embodiment of the present invention, a method of fabricating a display apparatus includes preparing a substrate including a display area having a transmissive region and a reflective region and a peripheral area surrounding the display area, forming a common electrode in the display area of the substrate, forming a gate line spaced apart from the common electrode and a gate electrode branching from the gate line, and forming a data line crossing the gate line to define a pixel area in the display area, a source electrode branching from the data line, a drain electrode being spaced apart from the source electrode and facing the source electrode, and a reflective electrode being formed in the pixel area by extending the drain electrode into the pixel area and being provided with at least one opening to define the transmissive region and the reflective region.

### BRIEF DESCRIPTION OF THE DRAWINGS

Exemplary embodiments of the present invention can be understood in detail from the following description taken in conjunction with the accompanying drawings of which:

FIG. 1 is a sectional view showing an LCD device according to an exemplary embodiment of the present invention;

FIG. 2 is a plan view showing an LCD device according to an exemplary embodiment of the present invention;

FIG. 3 is a sectional view taken along the line I-I′ shown in FIG. 2 according to an exemplary embodiment of the present invention;

FIG. 4A is a schematic view of a pad section shown in FIG. 2 according to an exemplary embodiment of the present invention;

FIG. 4B is a sectional view taken along the line III-III′ shown in FIG. 4A according to an exemplary embodiment of the present invention;

FIG. 4C is a sectional view taken along the line III-III′ shown in FIG. 4A according to an exemplary embodiment of the present invention;

FIG. 5A is a schematic view of a pad section shown in FIG. 2 according to an embodiment of the present invention;

FIG. 5B is a sectional view taken along the line III-III′ shown in FIG. 5A according to an exemplary embodiment of the present invention;

FIGS. 6A to 11B are sectional views for showing a fabrication method for an LCD device according to an exemplary embodiment of the present invention; and

FIGS. 12A to 16B are sectional views for showing a fabrication method for an LCD device according to an exemplary embodiment of the present invention.

### DESCRIPTION OF EXEMPLARY EMBODIMENTS

Exemplary embodiments of the present invention will be described in detail with reference to the accompanying drawings. The present invention may, however, be embodied in many different forms and should not be construed as limited to the embodiments set forth herein.

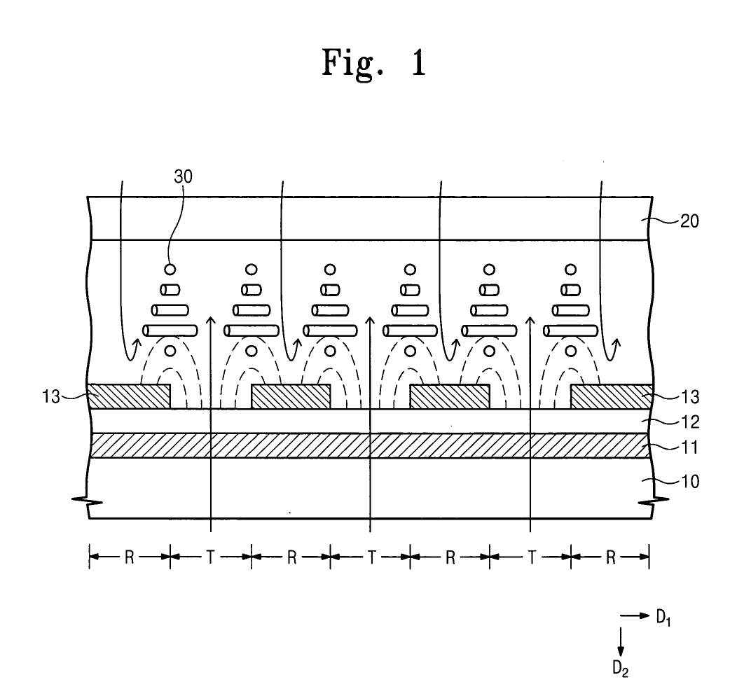

FIG. 1 is a sectional view showing a single pixel of a liquid crystal display (LCD) device according to an embodiment of the present invention.

Referring to FIG. 1, the LCD device includes first and second substrates 10 and 20, which are substantially parallel to each other, and liquid crystals 30 aligned between the first and second substrates 10 and 20. The first substrate 10 includes a bottom electrode 11, an insulating layer 12, and a top electrode 13 sequentially formed thereon. The bottom electrode 11 is integrally formed with a predetermined portion of the first substrate 10. The insulating layer 12 is interposed between the bottom electrode 11 and the top electrode 13 to insulate the bottom electrode 11 from the top electrode 13. The top electrode 13 is opened, for example, regularly, at various portions thereof. The first substrate 10 is divided into reflective regions R, where the bottom electrode 11 corresponds to the top electrode 13 in the upward direction, and transmissive regions T, where the bottom electrode 11 corresponds to the open portions of the top electrode 13 in the upward direction.

A common voltage is applied to the bottom electrode 11. A data voltage, which may vary depending on an image to be displayed, is applied to the top electrode 13. Due to the potential difference between the common voltage and the data voltage, an electric field is generated between the first and second substrates 10 and 20. The electric field is generated over the entire area of the reflective regions R and transmissive regions T and forms an inverse-parabolic pattern (see, dotted lines in FIG. 1).

The electric field comprises a first directional component and a second directional component substantially perpendicular to the first directional component. The first directional component of the electric field is substantially parallel to the first substrate 10 and is generated because the reflective regions R and the transmissive regions T are alternately aligned in the first direction D₁. The first directional component of the electric field twists the liquid crystal 30 in a plane parallel to the first substrate 10.

The second directional component of the electric field is substantially perpendicular to the first substrate 10 and is generated because the step difference occurs between the reflective regions R and the transmissive regions T in the second direction D₂ due to the open portions of the top electrode 13. The second directional component of the electric field tilts the liquid crystal 30 with respect to the first substrate 10.

In an LCD device according to an embodiment of the present invention, the first directional component exerts a greater force upon the liquid crystal 30 than the second directional component. The liquid crystal 30 is realigned as the liquid crystal 30 is twisted in the plane parallel to the first substrate 10. Accordingly, the refractive index of the liquid crystal 30 measured from the front of the LCD device is not substantially different from the refractive index of the liquid crystal 30 measured from the lateral side of the LCD device, so the LCD device may represent a wide viewing angle.

The LCD device operates in a reflective mode at the reflective regions R and operates in a transmissive mode at the transmissive regions T. When the LCD device operates in the reflective mode, the LCD device displays images using light incident thereon from an exterior of the device. When the LCD device operates in the transmissive mode, the LCD device displays images using light generated from a light emitting device installed therein.

When the LCD device operates in the reflective mode, a reflective electrode is used to reflect light incident thereon from the exterior of the device. According to an embodiment of the present invention, the top electrode 13 serves as the reflective electrode, instead of using a separate reflective electrode. The top electrode 13 may include, for example, silver (Ag), aluminum (Al), or an aluminum (Al) alloy having a superior light reflectance. The light incident into the reflective regions Rthrough the second substrate 20 is reflected from the top electrode 13 so that the light is output toward the second substrate 20 by passing through the liquid crystal 30.

The light generated from the light emitting device (not shown) provided below the first substrate 10 is radiated onto the transmissive regions T, so that the light is output toward the second substrate 20 through the bottom electrode 11 and the liquid crystal 30. The bottom electrode 11 may include, for example, indium zinc oxide (IZO) or indium tin oxide (ITO) such that the light can pass through the bottom electrode 11.

According to an embodiment of the present invention, the bottom electrode 11 and the top electrode 13 are sequentially aligned on the first substrate 10, thereby widening the viewing angle of the liquid crystal 30. The top electrode 13 is utilized as the reflective electrode without using a separate reflective electrode, so that the LCD device may operate in a transflective mode. Since the LCD device according to an embodiment of the present invention can be operated in the reflective mode by using the external light, power consumption of the LCD device can be reduced. Since the LCD device according to an embodiment of the present invention can be operated in the transmissive mode, the LCD device can display images where the external light is not sufficient to display the images.

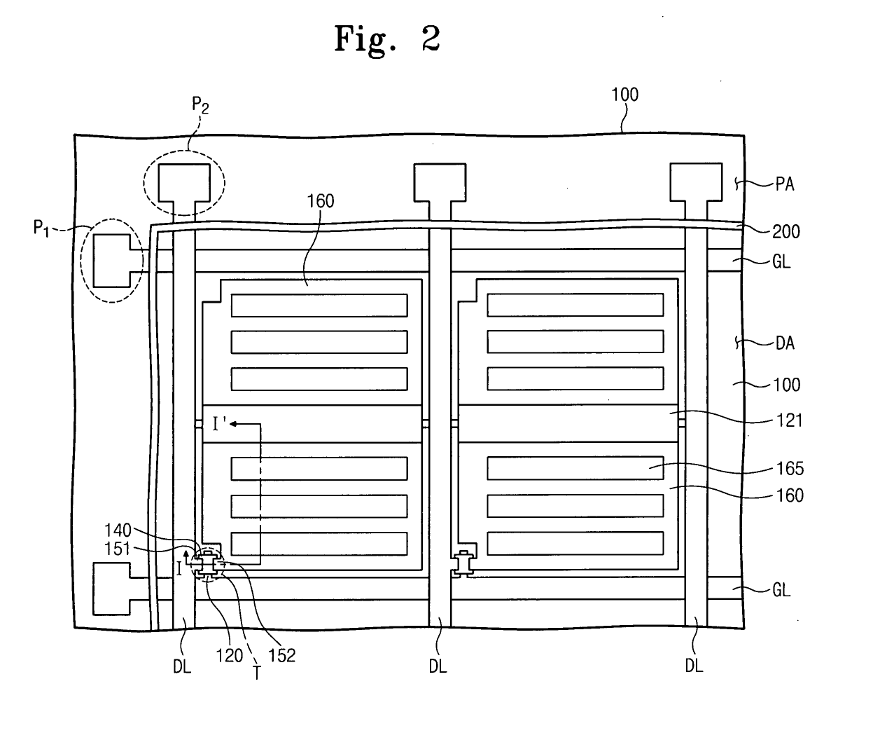

FIG. 2 is a plan view showing an LCD device according to an exemplary embodiment of the present invention.

Referring to FIG. 2, the LCD device includes a first substrate 100 and a second substrate 200 facing the first substrate 100. In an embodiment, the first substrate 100 can be larger than the second substrate 200, and can be divided into a display area DA and a peripheral area PA. The display area DA is formed in a predetermined region of the first substrate 100 facing the second substrate 200. An image is displayed on a predetermined region of the second substrate 200 corresponding to the display area DA. The peripheral area PA is formed at the peripheral region of the first substrate 100. Signals used to operate the LCD device are transmitted from the peripheral area PA.

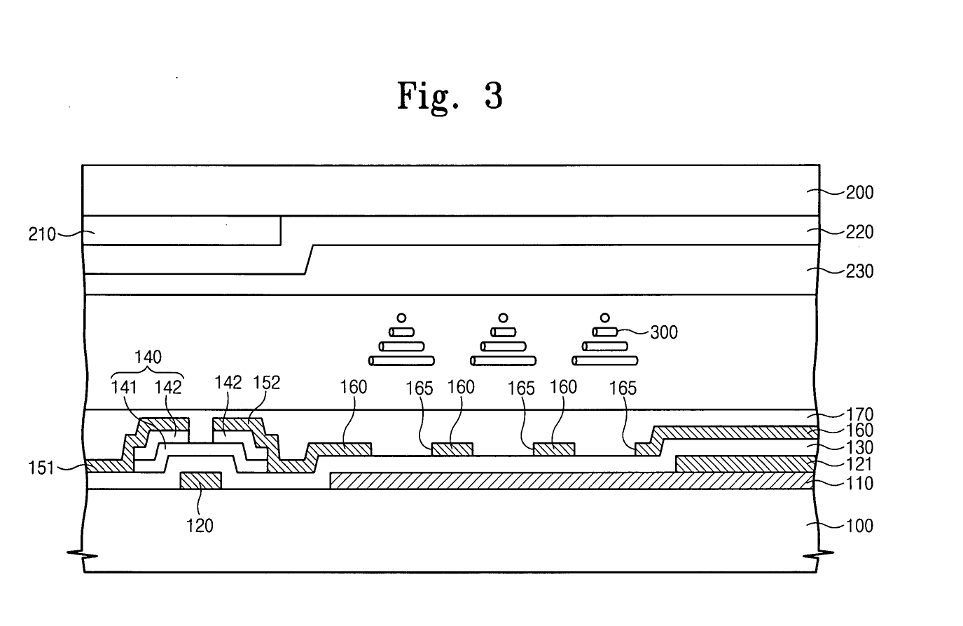

In FIG. 2, although the second substrate 200 is partially removed to show components formed on the first substrate 100, such as, for example, gate lines, data lines, and thin film transistors, the second substrate 200 is combined with the first substrate 100 to allow the components to be entirely covered with the second substrate 200 (see FIG. 3).

Wire lines GL and DL are formed on the first substrate 100 and cross each other. A pixel area is defined in the display area DA by the wire lines GL and DL crossing each other. The wire lines GL and DL include gate lines GL aligned in a row direction and data lines DL aligned in a column direction. In the peripheral area PA, gate pads P₁ are respectively formed at end portions of the gate lines GL to provide the gate signal to the gate lines GL. Data pads P₂ are respectively formed at end portions of the data lines DL to provide the data signal to the data lines DL.

A thin film transistor T, a reflective electrode 160, and a common line 121 is provided in each pixel area. The thin film transistor T is connected to the reflective electrode 160 and includes a conductive material having a superior light reflectance. A plurality of openings 165 are formed at predetermined portions of the reflective electrode 160. The openings 165 of the reflective electrode 160 are spaced apart from each other by a predetermined interval. The common line 121 is provided in the center of the pixel area. The openings 165 are symmetrically aligned with respect to the common line 121.

FIG. 3 is a sectional view taken along the line I-I′ shown in FIG. 2.

Referring to FIG. 3, a common electrode 110 is formed on the first substrate 100. The common electrode 110 has no openings and is formed over the entire region of the pixel area. The common line 121 is aligned on the common electrode 110. A common voltage is applied to the common electrode 110 through the common line 121. A gate electrode 120 is formed on the first substrate 100 and is spaced apart from the common electrode 110. The gate electrode 120 branches from the gate line GL. The gate electrode 120, the common electrode 110 and the common line 121 are covered with a gate insulating layer 130.

A semiconductor pattern 140 is formed on the gate insulating layer 130. The semiconductor pattern 140 includes an active pattern 141 and an ohmic contact pattern 142 stacked on the active pattern 141. The semiconductor pattern 140 can be obtained by patterning a semiconductor layer, for instance, an amorphous silicon layer. The active pattern 141 can be an intrinsic semiconductor layer and the ohmic contact pattern 142 can be a semiconductor layer including impurities.

A source electrode 151 and a drain electrode 152 are formed on the semiconductor pattern 140 such that the source electrode 151 and the drain electrode 152 are separated from each other along the ohmic contact pattern 142. The source electrode 151 branches from the data line DL, and the drain electrode 152 is spaced apart from the source electrode 151. The thin film transistor T comprises the gate electrode 120, the semiconductor pattern 140, the source electrode 151 and the drain electrode 152.

The drain electrode 152 extends toward the pixel area, thereby forming the reflective electrode 160. Thus, the reflective electrode 160 faces the common electrode 110 in the pixel area. The common electrode 110 is partially covered by the gate insulating layer 130 excluding regions corresponding to the openings 165 of the reflective electrode 160. The data voltage is applied to the reflective electrode 160 using the thin film transistor T, and the common voltage is applied to the common electrode 110 through the common line 121. The reflective electrode 160 and the thin film transistor T are covered with a protective layer 170 to be protected from external impact.

A light blocking pattern 210, a color filter 220 and an overcoat layer 230 are formed on the second substrate 200. The light blocking pattern 210 includes an opaque film aligned on a boundary region of the pixel area of the first substrate 100. The light blocking pattern 210 blocks light when the light is transferred to the reflective electrode 160 and the common electrode 110 by passing through uncontrolled parts, for example, the thin film transistor T, in each pixel area.

The color filter 220 is formed on the second substrate 200 and corresponds to the pixel area. The color filter 220 filters light having a specific wavelength from white light to display color images. The color filter 220 may include, for example, a red filter, a green filter, and a blue filter to filter the light having wavelengths corresponding to three primary colors.

The overcoat layer 230 can be formed on the color filter 220. The overcoat layer 230 protects the color filter 220 and planarizes the surface of the second substrate 200 when the surface of the second substrate 200 is uneven by the color filter 220 and the light blocking pattern 210.

The gate signal is applied to the gate lines GL, and the data signal is applied to the data lines DL based on image information. As the thin film transistor T is turned on according to the gate signal, the data voltage corresponding to the data signal is applied to the reflective electrode 160, and the common voltage is applied to the common electrode 110 through the common line 121.

Accordingly, the electric field is generated in parallel to the first and second substrates 100 and 200 due to the potential difference between the data voltage and the common voltage, so that the liquid crystal 300 is subject to the electric field. As the electric field is applied to the liquid crystal 300, the alignment of liquid crystal molecules may be changed, so that images can be displayed according to the alignment of the liquid crystal 300 and transmittance of the light passing through the liquid crystal 300.

Light that passes through the liquid crystal 300 can be provided from an exterior, or can be generated from a backlight unit (not shown) installed in the LCD device. The light incident into the LCD device from the exterior passes through the liquid crystal 300 after being reflected from the reflective electrode 160. The light generated from the backlight unit passes through the liquid crystal 300 via the openings 165 formed in the reflective electrode 160. Therefore, the openings 165 of the reflective electrode 160 may define the transmissive area, and other parts of the reflective electrode 160 excluding the openings 165 may define the reflective area.

A ratio of the reflective area to the transmissive area in the single pixel area is determined according to application fields of the LCD device. When the LCD device is used in a place with sufficient external light, the ratio of the reflective area to the transmissive area is increased to reduce power consumption. If the LCD device is used in a place without sufficient external light, the ratio of the transmissive area to the reflective area is increased.

The gate pad P₁ and data pad P₂ can be provided in the peripheral area PA with various shapes according to embodiments of the present invention.

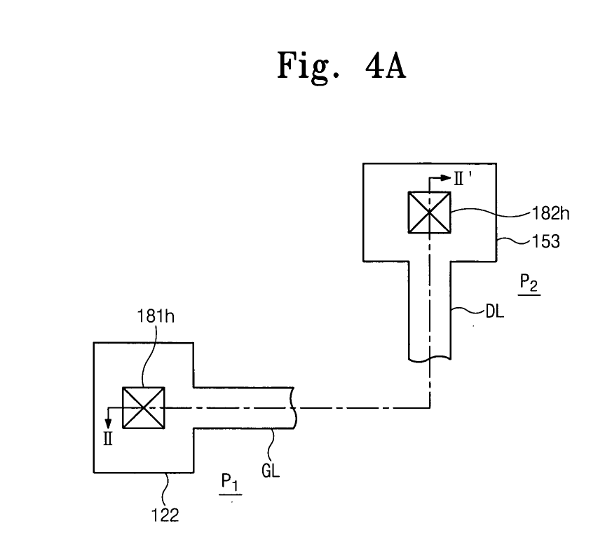

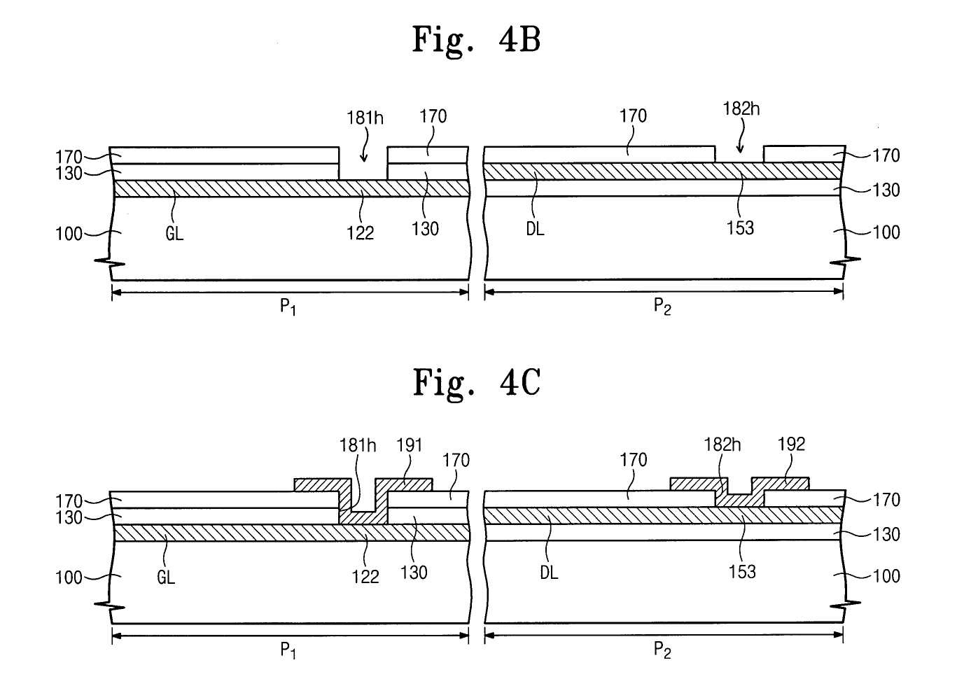

FIG. 4A is a schematic view of the gate pad P₁ and the data pad P₂ shown in FIG. 2 according to an embodiment of the present invention. FIG. 4B is a sectional view taken along the line II-II′ shown in FIG. 4A according to an exemplary embodiment of the present invention. FIG. 4C is a sectional view taken along the line II-II′ shown in FIG. 4A according to an embodiment of the present invention.

Referring to FIGS. 4A and 4B, the gate pad P₁ includes a gate terminal 122 provided at an end portion of the gate line GL. The gate terminal 122 is covered with the gate insulating layer 130 and the protective layer 170. The gate insulating layer 130 and the protective layer 170 have a gate contact hole 181h through which the gate terminal 122 is exposed. An output terminal of a gate drive circuit (not shown) is connected the exposed portion of the gate terminal 122. The gate drive circuit generates gate signals applied to the gate line GL through the gate terminal 122.

The data pad P₂ includes a data terminal 153 provided at an end portion of the data line DL. The data terminal 153 is formed on the gate insulating layer 130 and is covered with the protective layer 170. The protective layer 170 has a data contact hole 182h to expose the data terminal 153. An output terminal of a data drive circuit (not shown) is connected the exposed portion of the data terminal 153. The data drive circuit generates data signals applied to the data line DL through the data terminal 153.

Referring to FIG. 4C, the gate pad P₁ and data pad P₂ may include, for example, a gate protective terminal 191 and a data protective terminal 192, respectively. When a chemically unstable material is used for the gate terminal 122 or the data terminal 153, the gate terminal 122 or the data terminal 153, which is exposed through the gate contact hole 181h or the gate contact hole 182h, may be eroded. To prevent the erosion of the gate and data terminals 122 and 153, the gate protective terminal 191 and the data protective terminal 192 are provided to protect the gate terminal 122 and the data terminal 153, respectively. The gate protective terminal 191 and the data protective terminal 192 may include substantially the same materials as those of the common electrode 110, such as, for example, indium zinc oxide or indium tin oxide. Such indium zinc oxide or indium tin oxide is a chemically stable material, so the gate protective terminal 191 and the data protective terminal 192 can prevent the gate terminal 122 and the data terminal 153 from being eroded.

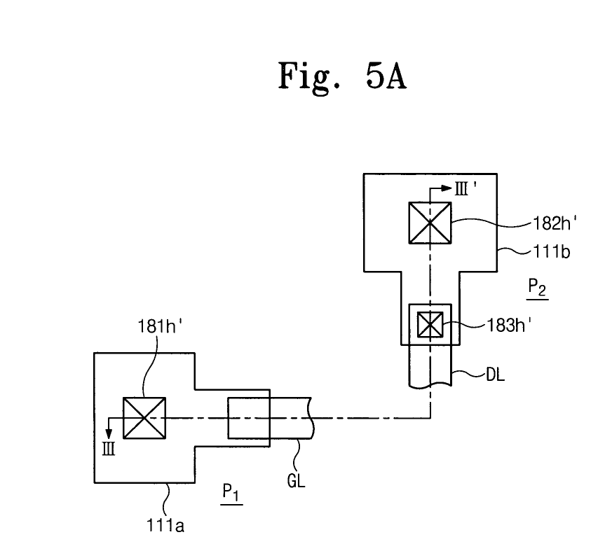

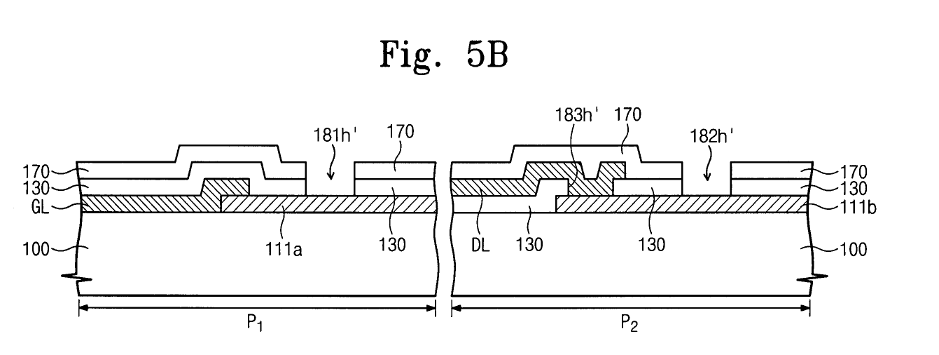

FIG. 5A is a schematic view of a pad section shown in FIG. 2 according to an embodiment of the present invention. FIG. 5B is a sectional view taken along the line III-III′ shown in FIG. 5A.

Referring to FIGS. 5A and 5B, the gate pad P₁ includes a gate terminal 111a connected to the gate line GL. The gate terminal 111a is covered with the gate insulating layer 130 and the protective layer 170. The gate insulating layer 130 and the protective layer 170 have a gate contact hole 181h′ to expose the gate terminal 111a. An output terminal of a gate drive circuit (not shown) is connected the exposed portion of the gate terminal 111a.

In an embodiment of the present invention, the gate terminal 111a includes substantially the same material as that of the common electrode 110 such as, for example, indium zinc oxide or indium tin oxide, which is chemically stable, so the gate protective terminal 191 can be omitted.

The data pad P₂ includes a data terminal 111b electrically connected to the data line DL. The gate insulating layer 130 is formed between the data terminal 111b and the data line DL. A first data contact hole 183h′ is formed in the gate insulating layer 130 to electrically connect the data terminal 111b with the data line DL. The gate insulating layer 130 and the protective layer 170 cover the data terminal 111b and have a second data contact hole 182h′ to expose the data terminal 111b. An output terminal of a data drive circuit (not shown) is connected the exposed portion of the data terminal 111b.

In an embodiment of the present invention, an example of the data terminal 111b may include substantially the same material as that of the gate terminal 111a. Such a material can be chemically stable, so the data protective terminal 192 can be omitted.

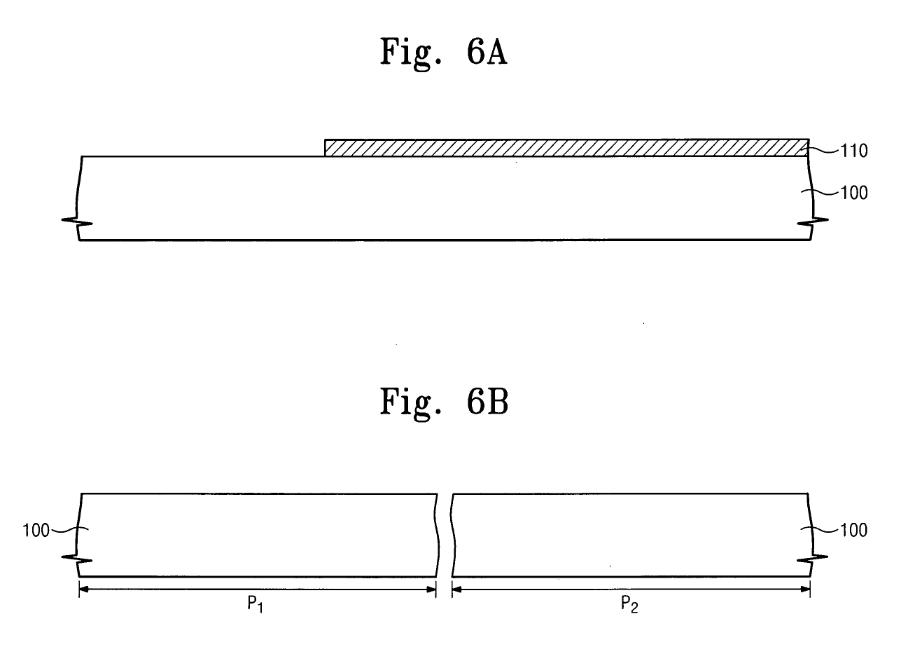

FIGS. 6A to 11B are sectional views for use in showing a fabrication method for an LCD device according to an exemplary embodiment of the present invention.

Referring to FIGS. 6A and 6B, a transparent conductive layer is formed on the surface of the first substrate 100. The first substrate 100 includes, for example, a glass substrate or a plastic substrate having transparent and insulating properties. The transparent conductive layer is deposited on the surface of the first substrate 100 through a sputtering method by using, for example, indium zinc oxide or indium tin oxide. The transparent conductive layer is etched by using, for example, a photoresist pattern. Thus, the transparent conductive layer remains on a predetermined region of the first substrate 100, thereby forming the common electrode 110.

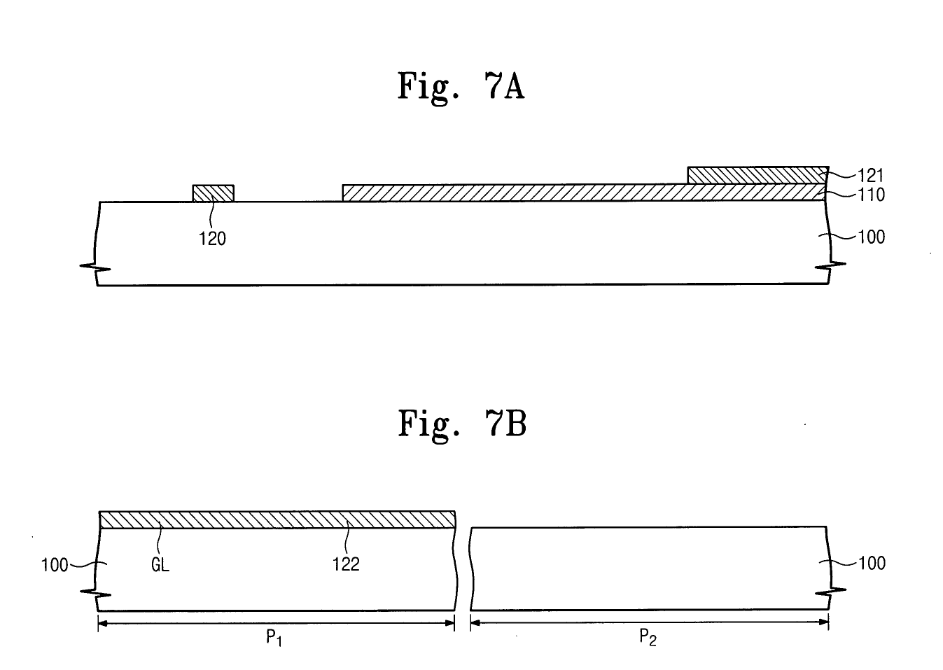

Referring to FIGS. 7A and 7B, a gate conductive layer is formed on the surface of the first substrate 100. The gate conductive layer is deposited on the surface of the first substrate 100 through the sputtering method. The gate conductive layer can be a single layer or a multi-layer including, for example, chrome, aluminum, an aluminum alloy, or molybdenum.

The gate conductive layer can be etched by using, for example, the photoresist pattern. Thus, the gate conductive layer remains on a predetermined region of the first substrate 100 to form the gate line GL, the gate electrode 120, the common line 121 and the gate terminal 122. The gate electrode 120 branches from the gate line GL and is spaced apart from the common electrode 110. The common line 121 is formed on the common electrode 110 and the gate terminal 122 is formed at an end portion of the gate line GL.

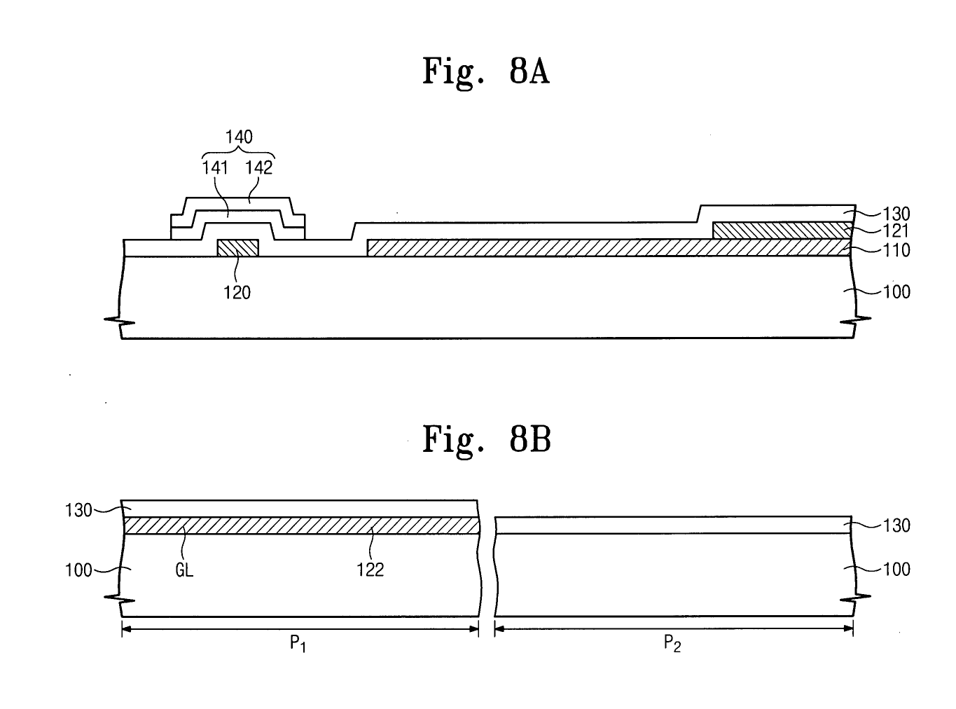

Referring to FIGS. 8A and 8B, the gate insulating layer 130 and the semiconductor layer are formed on the surface of the first substrate 100. The gate insulating layer 130 and the semiconductor layer are deposited on the surface of the first substrate 100 through, for example, a plasma chemical vapor deposition method.

The gate insulating layer 130 includes an inorganic material, such as, for example, silicon nitride. The gate insulating layer 130 is formed on the surface of the first substrate 100 to cover the gate electrode 120, the common electrode 110 and the gate terminal 122.

The semiconductor layer can have a double layer structure comprising an active layer including, for example, amorphous silicon and an ohmic contact layer doped with impurity ions and stacked on the active layer. The semiconductor layer can be etched by using the photoresist pattern so that the semiconductor pattern 140 is formed. The semiconductor pattern 140 is provided in a predetermined region of the gate electrode 120 and includes an active pattern 141 and an ohmic contact pattern 142.

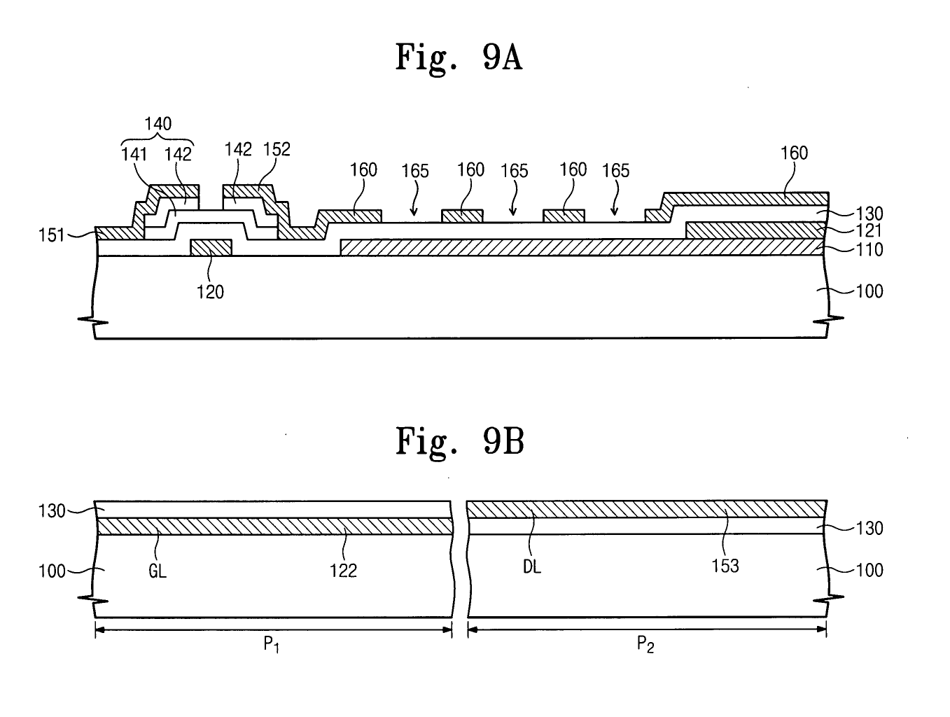

Referring to FIGS. 9A and 9B, a data conductive layer is formed on the surface of the first substrate 100. The data conductive layer is patterned in a substantially same manner as the gate conductive layer. As a result of patterning the data conductive layer, the data line DL, the source electrode 151, the drain electrode 152, the reflective electrode 160 and the data terminal 153 are formed.

The source electrode 151 branches from the data line DL. The drain electrode 152 is spaced apart from the source electrode 151. The reflective electrode 160 is connected with the drain electrode 152 and is formed with a plurality of openings 165. The data terminal 153 is formed at an end portion of the data line DL.

The ohmic contact pattern 142 provided below the source electrode 151 and the drain electrode 152 is etched. The ohmic contact pattern 142 is divided along the source electrode 151 and the drain electrode 152. The thin film transistor T including the gate electrode 120, the semiconductor pattern 140, the source electrode 151 and the drain electrode 152 is formed.

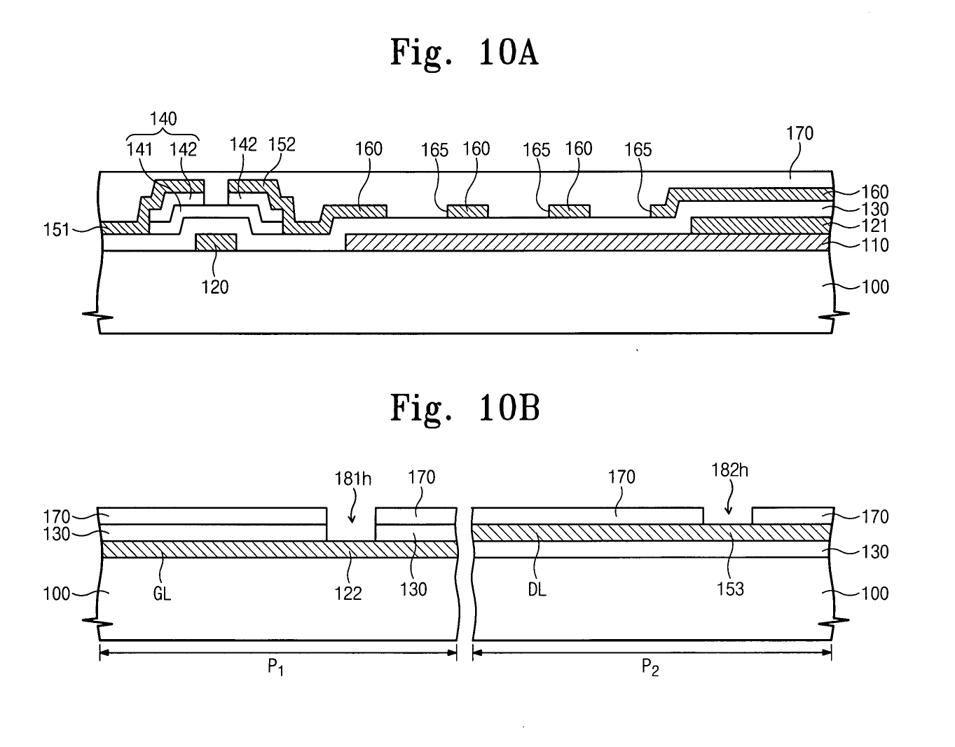

Referring to FIGS. 10A and 10B, the protective layer 170 is formed on the surface of the first substrate 100. The protective layer 170 is deposited on the surface of the first substrate 100 using, for example, the plasma chemical vapor deposition method, and may include, for example, silicon nitride. The protective layer 170 is etched by using the photoresist pattern and is formed with the contact holes 181h and 182h.

The contact holes 181h and 182h include the gate contact hole 181h formed in the gate terminal 122 and the data contact hole 182h formed in the data terminal 153. The gate contact hole 181h passes through the protective layer 170 and the gate insulating layer 130 provided below the protective layer 170. Thus, the gate terminal 122 is exposed through the gate contact hole 181h. The data contact hole 182h is defined in the protective layer 170 to expose the data terminal 153 therethrough.

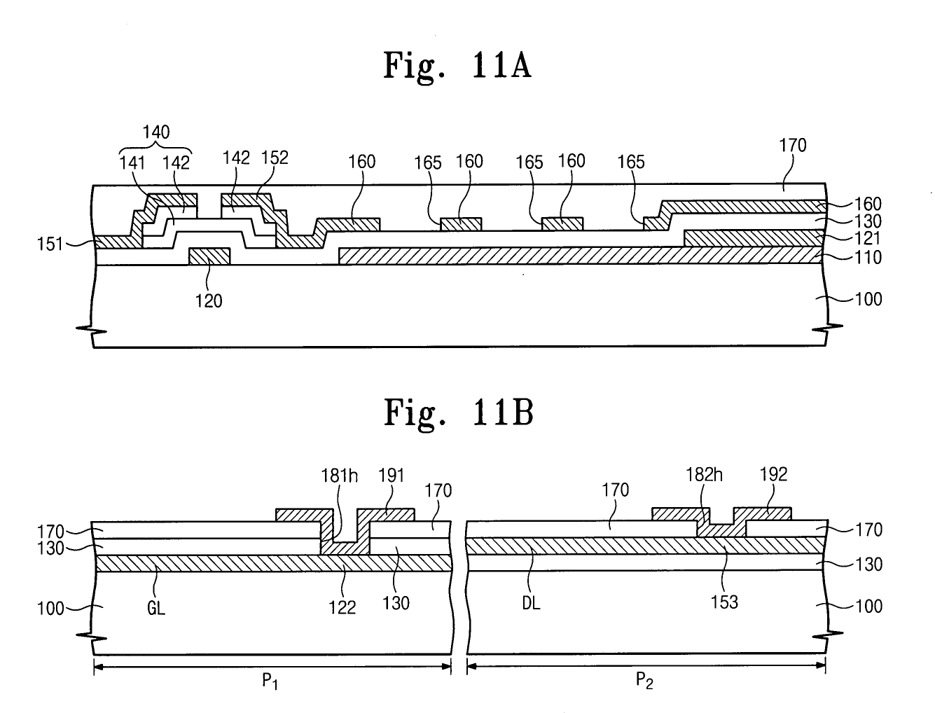

Referring to FIGS. 11A and 11B, the transparent conductive layer is deposited on the surface of the first substrate 100. The transparent conductive layer includes substantially the same material as that of the common electrode 110 and is formed through substantially the same method as the method of forming the common electrode 110. The transparent conductive layer is deposited in such a manner that the transparent conductive layer is buried in the gate contact hole 181h and the data contact hole 182h. Then, the transparent conductive layer is patterned such that the transparent conductive layer remains only on the gate terminal 122 and the data terminal 153, thereby forming the gate protective terminal 191 and the data protective terminal 192.

The fabrication process for the second substrate 200 can be performed separately from the fabrication process for the first substrate 100 according to an embodiment of the present invention. The light blocking pattern 210, the color filter 220 and the overcoat layer 230 are sequentially formed on the second substrate 200. After that, the liquid crystal 300 is injected between the first and second substrates 100 and 200, and then the first and second substrates 100 and 200 are combined with each other, thereby obtaining the LCD device.

During the fabrication process for the first substrate 100, the patterning process is performed when forming the common electrode 110, the gate electrode 120, the semiconductor pattern 140, the source electrode 151, the drain electrode 152, the reflective electrode 160, the protective layer 170, the gate protective terminal 191 and the data protective terminal 192, respectively. Accordingly, the photolithography process must be performed by six times using six photo masks. The gate protective terminal 191 and the data protective terminal 192 can be omitted if the material having chemical stability against erosion is used for the gate and data terminals 122 and 153. In an embodiment of the present invention, the photolithography process can be performed by five times using five photo masks.

According to an embodiment of the present invention, the gate protective terminal 191 and the data protective terminal 192 can be omitted even if the photolithography process is performed using six photo masks.

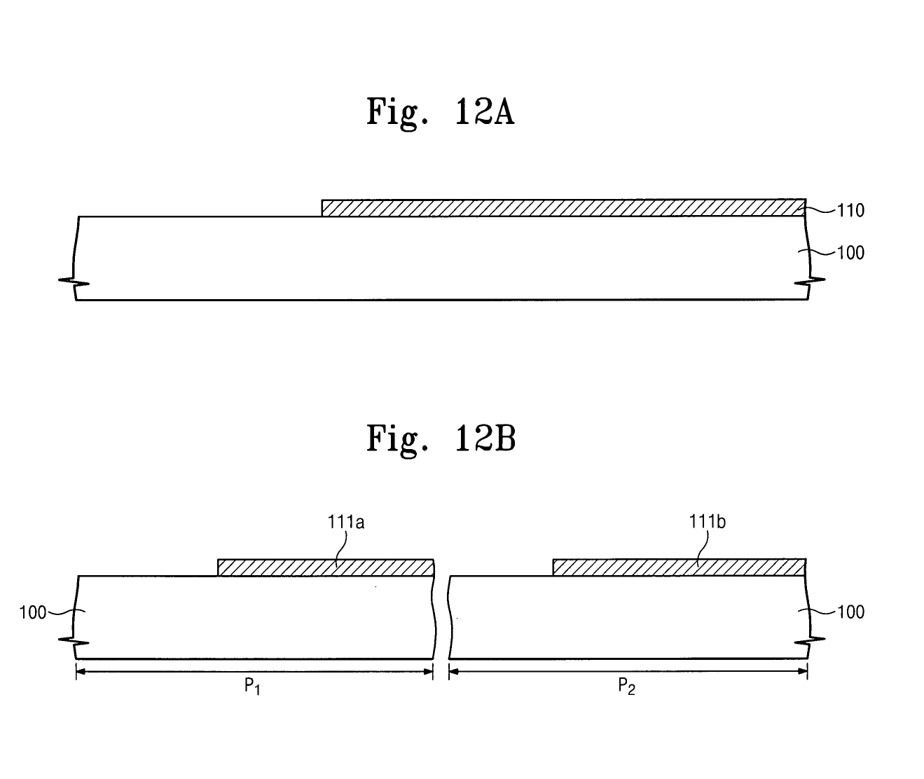

FIGS. 12A to 16B are sectional views showing a fabrication method for an LCD device according to an embodiment of the present invention.

Referring to FIGS. 12A and 12B, a transparent conductive layer is formed on the surface of the first substrate 100. The transparent conductive layer is patterned, so that the common electrode 110, the gate terminal 111a and the data terminal 111b are formed.

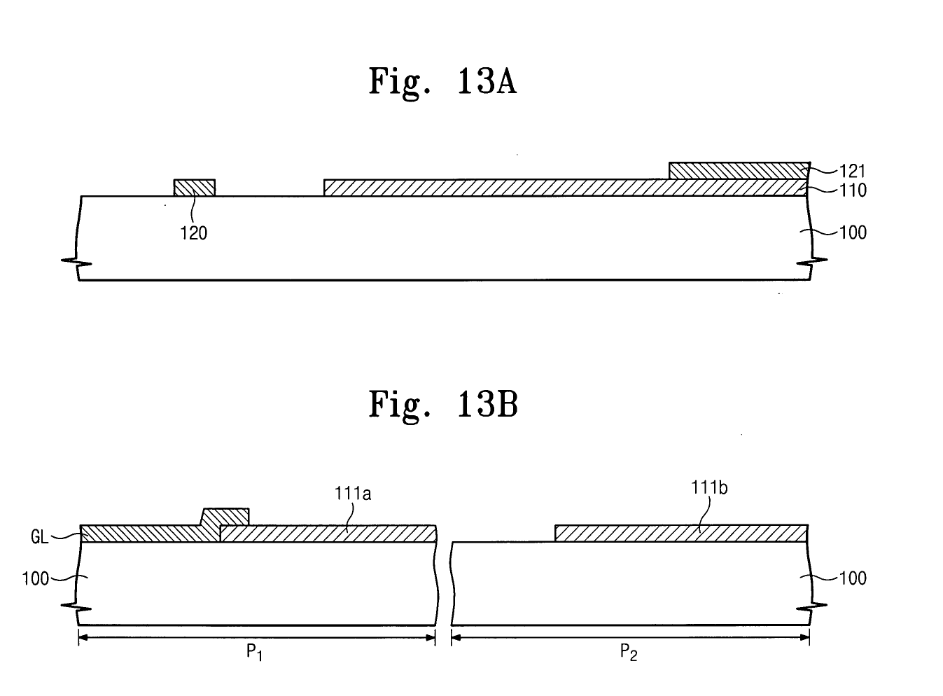

Referring to FIGS. 13A and 13B, the gate conductive layer is formed on the surface of the first substrate 100. Then, the gate conductive layer is patterned so that the gate line GL, the gate electrode 120 and the common line 121 are formed. The gate line GL is provided on the gate terminal 111a and is connected to the gate terminal 111a.

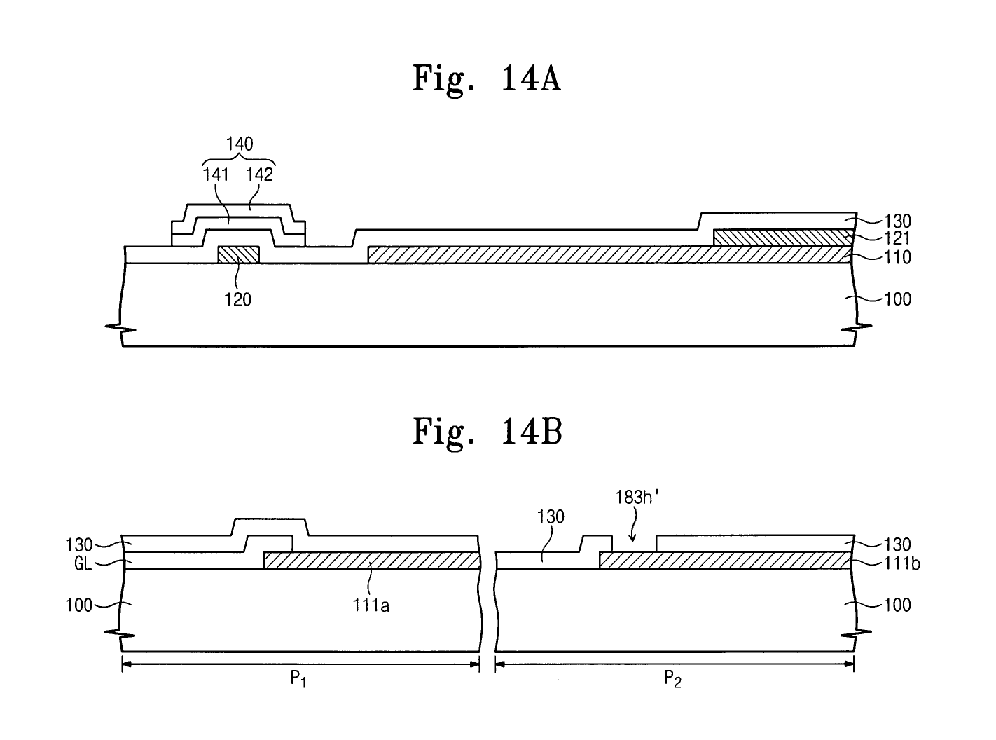

Referring to FIGS. 14A and 14B, the gate insulating layer 130 is formed on the surface of the first substrate 100. The gate insulating layer 130 is patterned so that the first data contact hole 183′, which exposes the data terminal 111b, can be formed in the gate insulating layer 130.

The semiconductor layer is formed on the gate insulating layer 130. Then, the semiconductor layer is patterned such that the semiconductor pattern 140 is formed on the gate electrode 120. The semiconductor pattern 140 includes the active pattern 141 and the ohmic contact pattern 142 stacked on the active pattern 141.

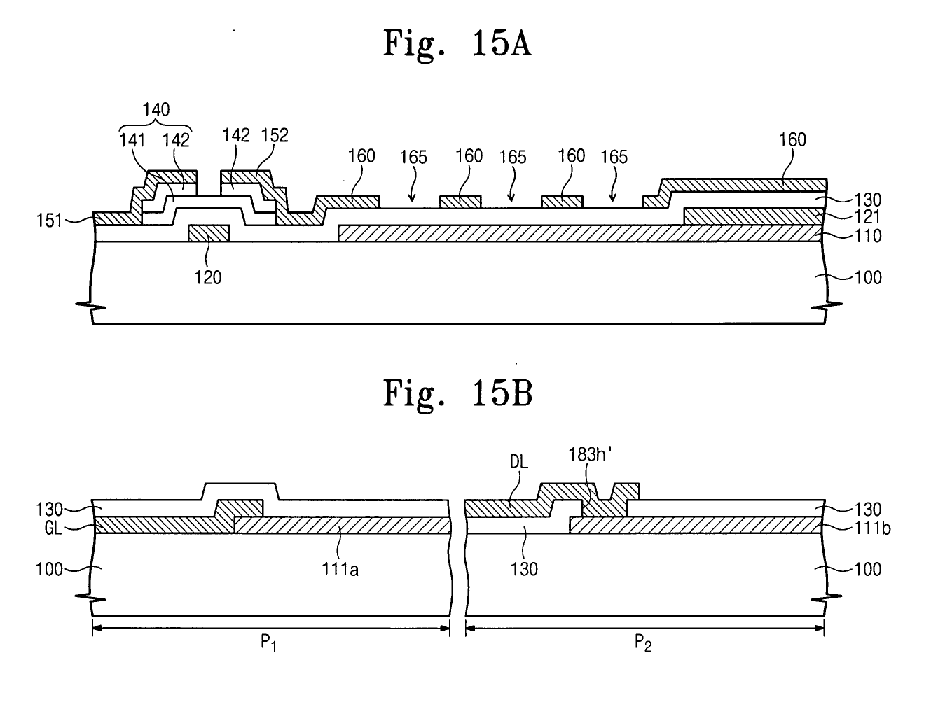

Referring to FIGS. 15A and 15B, the data conductive layer is formed on the surface of the first substrate 100. The data conductive layer is deposited on the surface of the first substrate 100 so that the data conductive layer is buried in the first data contact hole 183h′. Then, the data conductive layer is patterned, so that the data line DL, the source electrode 151, the drain electrode 152, and the reflective electrode 160 are formed. The data line DL is electrically connected to the data terminal 111b through the first data contact hole 183h′.

The ohmic contact pattern 142 is etched such that the ohmic contact pattern 142 is divided into two parts corresponding to the source electrode 151 and the drain electrode 152. Thus, the thin film transistor T including the gate electrode 120, the semiconductor pattern 140, the source electrode 151, and the drain electrode 152 is provided.

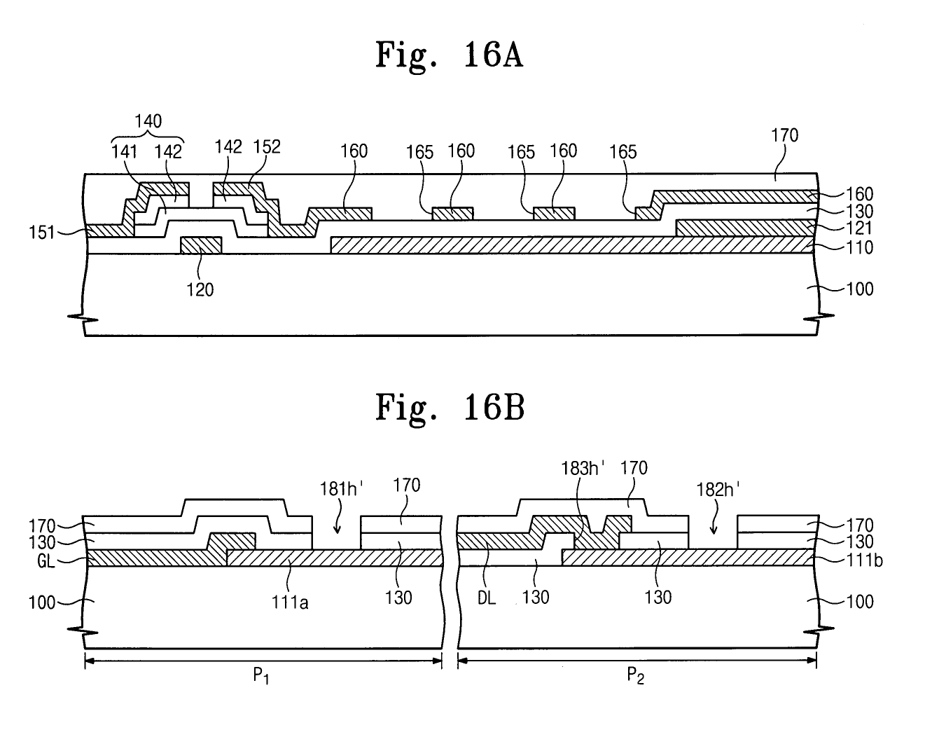

Referring to FIGS. 16A and 16B, the protective layer 170 is formed on the surface of the first substrate 100. The protective layer 170 and the gate insulating layer 130 are substantially simultaneously etched, so that the gate contact hole 181h′ and the second data contact hole 182h′ are formed through the protective layer and the gate insulating layer 130. The gate terminal 111a is exposed through the gate contact hole 181h′, and the data terminal 111b is exposed through the second data contact hole 182h′. The gate terminal 111a and the data terminal 111b include substantially the same material as that of the common electrode 110. Since the material for the gate and data terminals 111a and 111b is chemically stable against the erosion, the gate terminal 111a and the data terminal 111b can be prevented from being eroded even if the gate terminal 111a and the data terminal 111b are partially exposed to the exterior.

According to an embodiment of the present invention, the fabrication process for the second substrate 200 is performed separately from the fabrication process for the first substrate 100. The first substrate 100 is combined with the second substrate 200 while facing each other, thereby completing the LCD device.

In embodiments of the present invention, the transparent conductive layer forming the common electrode and the gate conductive layer forming the gate electrode are formed using the photoresist pattern, respectively. The photoresist pattern is prepared by performing the photolithography process twice using two different photo masks. However, since the transparent conductive layer and the gate conductive layer can be formed by performing the photolithography process once using one photo mask, the two-step photolithography process can be replaced with one-step photolithography process.

In an embodiment of the present invention, the photoresist pattern can be formed with a dual thickness structure after the transparent conductive layer and the gate conductive layer are deposited on the first substrate. The dual thickness structure of the photoresist pattern can be obtained by performing, for example, the photolithography process using a specific photo mask, such as, for example, a slit mask or a halftone mask. In a first etching step, the gate electrode is formed by etching the transparent conductive layer and the gate conductive layer formed on the transparent conductive layer. After that, a modified photoresist pattern, in which a smaller thickness part is removed from the dual thickness structure, is formed by etching the surface of the photoresist pattern having the dual thickness structure. In a second etching step, the exposed transparent conductive layer is etched by using the modified photoresist pattern, thereby forming the common electrode. Thus, the number of the photo masks can be reduced and the two-step photolithography process can be replaced with one-step photolithography process.

According to an embodiment of the present invention, the common electrode and the reflective electrode are aligned on the same substrate, so that the viewing angle of the LCD device is widened. Since the reflective electrode is formed by extending the drain electrode into the pixel area, the reflective electrode can be formed without performing an additional process.

According to an embodiment of the present invention, the LCD device can be operated in the transflective mode with a wide viewing angle, so that power consumption of the LCD device can be reduced. The reflective electrode required for the transflective operation of the LCD device can be formed without performing additional processes, so that the number of processing steps and the manufacturing cost for the LCD device can be reduced.

Although exemplary embodiments have been described with reference to the accompanying drawings, it is to be understood that the present invention is not limited to these precise embodiments but various changes and modifications can be made by one skilled in the art without departing from the spirit and scope of the present invention. All such changes and modifications are intended to be included within the scope of the invention as defined by the appended claims.

What is claimed is:

1. A display apparatus comprising:
a substrate including a display area having a transmissive region and a reflective region and a peripheral area surrounding the display area;
a gate line and a data line formed on the substrate and crossing each other to define a pixel area in the display area;
a gate electrode and a common electrode, wherein the gate electrode branches from the gate line in the pixel area and the common electrode is spaced apart from the gate electrode;
a source electrode and a drain electrode formed on the gate electrode, wherein the source electrode branches from the data line and the drain electrode is spaced apart from the source electrode; and
a reflective electrode formed in the pixel area by extending the drain electrode into the pixel area and provided with at least one opening to define the transmissive region and the reflective region.

2. The display apparatus of claim 1, further comprising a common line formed on the common electrode to provide a common voltage to the common electrode.

3. The display apparatus of claim 2, wherein the common line substantially parallel to the gate line is formed on a center portion of the reflective electrode and a plurality of openings are symmetrically formed with respect to the common line.

4. The display apparatus of claim 1, wherein the reflective electrode comprises aluminum, an aluminum alloy or silver, and the common electrode comprises indium zinc oxide or indium tin oxide.

5. The display apparatus of claim 1, further comprising a gate insulating layer formed on a surface of the substrate between the gate line and the data line, and a protective layer formed on the data line over a surface of the substrate.

6. The display apparatus of claim 5, further comprising a gate pad formed in the peripheral area to provide a gate signal to the gate line, wherein the gate pad includes a gate terminal formed at an end portion of the gate line and a gate protective terminal formed on the gate terminal to be electrically connected with the gate terminal through a gate contact hole, wherein the gate contact hole is formed through the gate insulating layer and the protective layer such that the gate terminal is exposed through the gate contact hole.

7. The display apparatus of claim 5, further comprising a data pad formed in the peripheral area to provide a data signal to the data line, wherein the data pad includes a data terminal formed at an end portion of the data line and a data protective terminal formed on the data terminal to be electrically connected with the data terminal through a data contact hole, wherein the data contact hole is formed through the protective layer such that the data terminal is exposed through the data contact hole.

8. The display apparatus of claim 5, further comprising a gate pad formed in the peripheral area to provide a gate signal to the gate line, wherein the gate pad includes a gate terminal connected to the gate line and exposed through a gate contact hole formed through the gate insulating layer and the protective layer.

9. The display apparatus of claim 8, wherein the gate terminal comprises substantially the same material as the common electrode.

10. The display apparatus of claim 5, further comprising a data pad formed in the peripheral area to provide a data signal to the data line, wherein the data pad includes a data terminal connected to the data line and exposed through a data contact hole formed in the protective layer.

11. The display apparatus of claim 10, wherein the data terminal comprises substantially the same material as the common electrode.

12. A method of fabricating a display apparatus, the method comprising:
preparing a substrate including a display area having a transmissive region and a reflective region and a peripheral area surrounding the display area;
forming a common electrode in the display area of the substrate;
forming a gate line spaced apart from the common electrode and a gate electrode branching from the gate line; and
forming a data line crossing the gate line to define a pixel area in the display area, a source electrode branching from the data line, a drain electrode being spaced apart from the source electrode and facing the source electrode, and a reflective electrode being formed in the pixel area by extending the drain electrode into the pixel area and being provided with at least one opening to define the transmissive region and the reflective region.

13. The method of claim 12, further comprising:
forming a common line, which provides a common voltage to the common electrode, wherein the common line is formed on the common electrode substantially simultaneously with the gate line.

14. The method of claim 12, further comprising:
forming a gate insulating layer on a surface of the substrate after forming the gate line such that the gate line is covered with the gate insulating layer; and
forming a protective layer on the surface of the substrate after forming the data line such that the data line is covered with the protective layer.

15. The method of claim 14, further comprising:
forming a gate pad in the peripheral area to provide a gate signal to the gate line,
wherein forming the gate pad includes:
forming a gate terminal on an end portion of the gate line in the peripheral area;
forming a gate contact hole through the gate insulating layer and the protective layer to expose the gate terminal through the gate contact hole; and
forming a gate protective terminal such that the gate protective terminal is electrically connected to the gate terminal through the gate contact hole.

16. The method of claim 14, further comprising:
forming a data pad in the peripheral area to provide a data signal to the data line,
wherein forming the data pad includes:
forming a data terminal on an end portion of the data line in the peripheral area;
forming a data contact hole through the gate insulating layer and the protective layer to expose the data terminal through the data contact hole; and
forming a data protective terminal such that the data protective terminal is electrically connected to the data terminal through the data contact hole.

17. The method of claim 14, further comprising:
forming a gate pad in the peripheral area to provide a gate signal to the gate line,
wherein forming the gate pad includes:
forming a gate terminal in the peripheral area while the common electrode is being formed;
connecting an end portion of the gate line onto the gate electrode; and
forming a gate contact hole through the gate insulating layer and the protective terminal such that the gate terminal is exposed through the gate contact hole.

18. The method of claim 14, further comprising:
forming a data pad in the peripheral area to provide a data signal to the data line,
wherein forming the data pad includes:
forming a data terminal in the peripheral area while the common electrode is being formed;
forming a first data contact hole in the gate insulating layer such that the data terminal is exposed through the first data contact hole;
electrically connecting an end portion of the data line with the data electrode through the first data contact hole; and
forming a second data contact hole in the protective layer such that the data terminal is exposed through the second data contact hole.
